(19) United States
(12) Patent Application Publication
(10) Pub. No.: US 2018/0254529 A1
(43) Pub. Date: Sep. 6, 2018

(54) LITHIUM REPLENISHMENT FOR CONTAINING CAPACITY LOSS IN LI ION BATTERIES

(71) Applicant: FORD GLOBAL TECHNOLOGIES, LLC, Dearborn, MI (US)

(72) Inventors: RUTOOJ D. DESHPANDE, FARMINGTON HILLS, MI (US); SATISH B. CHIKKANNANAVAR, CANTON, MI (US)

(21) Appl. No.: 15/446,520

(22) Filed: Mar. 1, 2017

(51) Int. Cl. H01M 10/42; H01M 10/0525; H01M 10/0587; H01M 4/131; H01M 4/505; H01M 4/525; H01M 4/40; H01M 4/38; H01M 4/58

(52) U.S. Cl. CPC H01M 10/425; H01M 10/0525; H01M 10/0587; H01M 4/131; H01M 4/505; H01M 2220/20; H01M 4/405; H01M 4/386; H01M 4/58; H01M 2010/4271; H01M 4/525

(57) ABSTRACT

A lithium-ion battery includes a housing, an electrode assembly within the housing, and a high capacity regenerating electrode. The high capacity regenerating electrode is within the housing and electrically isolated from the electrode assembly. The high capacity regenerating electrode is also spaced away from and only corresponds to a single face of the electrode assembly. The high capacity regenerating electrode is configured to be selectively electrically connected to the electrode assembly to provide lithium ions to increase capacity of the electrode assembly.

### TECHNICAL FIELD

The present disclosure relates to increasing battery capacity of a lithium ion battery.

### BACKGROUND

Hybrid and electric vehicles depend on a traction battery to supply energy and/or power to propel the vehicle and power accessory loads. The traction battery may be made from a variety of chemical formulations. The traction battery may be made of a lithium-ion (Li-ion) compound. The capacity of the Li-ion battery tends to decrease over time as the battery ages and is subjected to repeated charge and discharge cycles. As the battery charge capacity decreases, less energy is stored in the battery, resulting in less range on full charge, lower fuel economy, and decreased vehicle performance.

### SUMMARY

According to an embodiment, a lithium-ion battery includes a housing, an electrode assembly within the housing, and a high capacity regenerating electrode. The high capacity regenerating electrode is within the housing and electrically isolated from the electrode assembly. The high capacity regenerating electrode is spaced away from and only corresponds to a single face of the electrode assembly. The high capacity regenerating electrode is configured to be selectively electrically connected to the electrode assembly to provide lithium ions to increase capacity of the electrode assembly.

In one or more embodiments, the electrode assembly may be a wound assembly, and the single face may be a flat face of the wound assembly. The high capacity regenerating electrode may include a separator encasing a current collector and a high capacity active material. The high capacity active material may be a high capacity cathode material and may be Ni-rich NMC, lithiated sulfur, or xLi₂MnO₃·(1-x)LiZO₂, wherein Z is Mn, Co, or Ni and x is a value between 0 and 1 representing a percentage for each component. The high capacity active material may be a high capacity anode material and may be lithiated metal hydride; lithiated SnO2, lithiated Co₃O₄, lithiated CuSn, or alloys thereof; lithiated Si; lithiated Sn; or lithiated Ge.

According to an embodiment, a system includes a battery having a housing, an electrode assembly within the housing, a high capacity regenerating electrode within the housing, and a controller. The high capacity regenerating electrode is electrically isolated from and spaced away from the electrode assembly. The high capacity regenerating electrode only corresponds to a single face of the electrode assembly, and is configured to be selectively electrically connected to the assembly via a circuit to increase capacity of the assembly. The controller configured to activate the circuit based on signals from a battery management system.

In one or more embodiments, the battery management system may be configured to monitor battery capacity and degradation and output signals regarding the same. The electrode assembly may be a wound assembly, and the single face may be a flat face of the wound assembly. The high capacity regenerating electrode may include a separator encasing a current collector and a high capacity active material. The high capacity active material may be a high capacity cathode material and may be Ni-rich NMC, lithiated sulfur, or xLi₂MnO₃·(1-x)LiZO₂, wherein Z is Mn, Co, or Ni and x is a value between 0 and 1 representing a percentage for each component. The high capacity active material may be a high capacity anode material and may be lithiated metal hydride; lithiated SnO₂, lithiated Co₃O₄, lithiated CuSn, or alloys thereof; lithiated Si; lithiated Sn; or lithiated Ge. The controller may be configured to set an initial capacity of the battery and a new initial capacity after capacity of the electrode assembly is increased.

According to an embodiment, a lithium-ion battery includes a housing, a wound electrode assembly within the housing and having at least one face, and a high capacity regenerating electrode within the housing. The high capacity regenerating electrode is electrically isolated from and spaced away from the electrode assembly. The high capacity regenerating electrode only corresponds to a single face of the electrode assembly. The high capacity regenerating electrode is configured to be selectively electrically connected to the electrode assembly via a regeneration circuit to provide lithium ions to increase capacity of the electrode assembly.

In one or more embodiments, the at least one face may be a flat face of the wound assembly. The high capacity regenerating electrode may include a separator encasing a current collector and a high capacity active material. The regeneration circuit may be activated by a controller responsive to signals from a battery management system configured to monitor battery capacity and degradation.

### BRIEF DESCRIPTION OF THE DRAWINGS

FIG. 1 is a schematic diagram of a hybrid-electric vehicle illustrating typical drivetrain and energy storage components.

FIG. 2A is a schematic illustration of an exemplary battery with a lithium regenerating electrode and battery management system.

FIG. 2B is a schematic illustration of an exemplary battery with a lithium regenerating electrode and battery management system.

FIG. 2C is a schematic illustration of an exemplary battery with a lithium regenerating electrode and battery management system.

FIG. 3 is a schematic illustration of a lithium regenerating electrode.

FIG. 4 is an exemplary graph of capacity degradation over time in a Li-ion battery.

FIG. 5 is an exemplary graph of cell voltage vs. cell capacity at various stages of battery life.

FIG. 6 is a flowchart illustrating a method for increasing the capacity of the Li-ion battery.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

The embodiments of the present disclosure generally provide for a plurality of circuits or other electrical devices. All reference to the circuits and other electrical devices and the functionality provided by each, are not intended to be limited to encompassing only what is illustrated and described herein. While particular labels may be assigned to the various circuits or other electrical devices disclosed, such labels are not intended to limit the scope of operation for the circuits and other electrical devices. Such circuits and other electrical devices may be combined with each other and/or separated in any manner based on the particular type of electrical implementation desired. It is recognized that any circuit or other electrical device disclosed herein may include any number of microprocessors, integrated circuits, memory devices (e.g, FLASH, random access memory (RAM, read only memory (ROM), electrically programmable read only memory (EPROM), electrically erasable programmable read only memory (EEPROM), or other suitable variants thereof) and software which co-act with one another to perform operation(s) disclosed herein. In addition, any one or more of the electric devices may be configured to execute a computer-program that is embodied in a non-transitory computer readable medium that is programmed to perform any number of the functions disclosed.

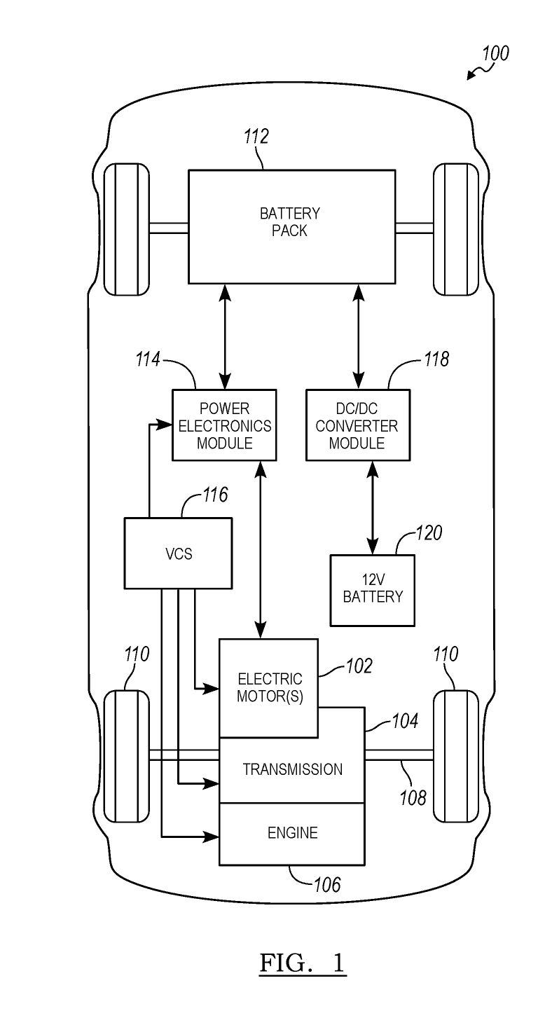

FIG. 1 shows a block diagram of an exemplary electric vehicle. A hybrid-electric vehicle (HEV) 100 is shown for illustrative purposes. The electric vehicle may be, without limitation, a battery electric vehicle (BEV), a hybrid electric vehicle, or a plug-in hybrid electric vehicle (PHEV). The HEV may include one or more electric motors 102 mechanically connected to a hybrid transmission 104. The hybrid transmission 104 is mechanically connected to an engine 106. The hybrid transmission 104 is also mechanically connected to a drive shaft 108, which is mechanically coupled to wheels 110. The HEV 100 may have a second drive shaft mechanically coupled to all four wheels for an all-wheel drive (AWD) vehicle. In an embodiment not illustrated, the hybrid transmission 104 may be a non-selectable gear transmission that may include at least one electric machine. The electric motors 102 provide propulsion and deceleration capability when the engine 106 is turned on or off. The electric motors 102 may also act as generators for providing fuel economy benefits by recovering energy that would normally be lost as heat in the friction braking system. The electric motors 102 may also reduce pollutant emissions since the HEV (or PHEV) 100 may be operated in electric mode under certain conditions.

A battery pack 112 may include, but is not limited to, a traction battery having one or more battery cells for storing energy, which can be used by the electric motors 102. The battery pack 112 typically provides a high voltage direct current (DC) output and is electrically connected to one or more power electronics modules 114. The power electronics module 114 may communicate with one or more control modules that make up vehicle computing system 116. The one or more modules may include, but are not limited to, a battery management system (BMS). The vehicle computing system 116 may control several vehicle features, systems, and/or subsystems. The power electronics module 114 is also electrically connected to the electric motors 102 and provides the ability to bi-directionally transfer energy between the battery pack 112 and the electric motors 102. For example, a typical battery pack 112 may provide a DC voltage while the electric motors 102 may require three-phase AC current to function. The power electronics module 114 may convert the DC voltage to a three-phase AC current as required by the electric motors 102. In a regenerative mode, the power electronics module 114 will convert the three-phase AC current from the electric motors 102 acting as generators to the DC voltage required by the battery pack 112. The description herein is equally applicable to a pure electric vehicle. For a pure electric vehicle, the hybrid transmission 104 may be a gear box connected to an electric machine, and the engine 106 may not be present.

In addition to providing energy for propulsion, the battery pack 112 may provide energy for other vehicle electrical systems. A typical system may include a DC/DC converter module 118 that converts the high voltage DC output of the battery pack 112 to a low voltage DC supply that is compatible with other vehicle loads. Other high voltage loads may be connected directly without the use of a DC/DC converter module 118. In a typical vehicle, the low voltage systems are electrically connected to a 12V battery 120.

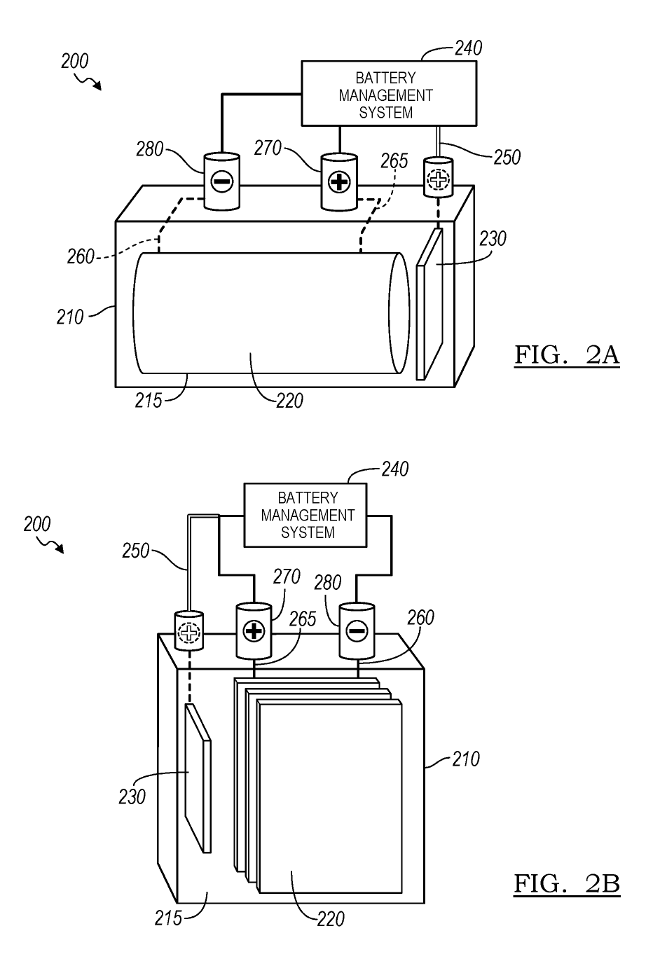

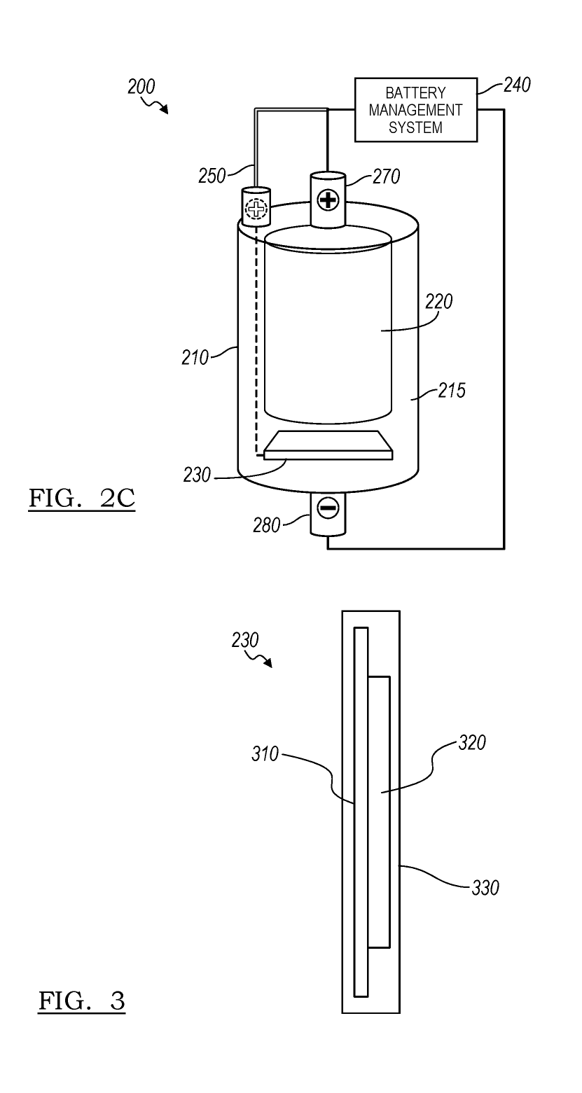

FIGS. 2A, 2B, and 2C show an exemplary traction battery 200 of battery pack 112 according to one or more embodiments. Battery pack 112 may be composed of one traction battery, or any number of individual battery cells connected in series or parallel or some combination thereof. For exemplary purposes, an individual traction battery 200 will be described. The battery 200 may be a prismatic, cylindrical, or pouch cell battery. Prismatic and cylindrical cells are shown in the Figures for illustrative purposes.

The battery 200 includes a housing 210. The housing contains an electrolyte 215. The electrolyte 215 may be any conventional electrolyte used in Li-ion batteries. For example, the electrolyte may be based on an organic solvent. The battery 200 also includes an electrode assembly 220, which may be a wound, or jelly roll, configuration (as shown). The electrode assembly 220 may alternatively be an electrode stack (i.e. layered assembly), with or without a separator. The electrode assembly 220 may be a primary electrode assembly. The electrode assembly 220 includes cathode electrode material, anode electrode material, separators, and current collectors. The cathode electrode material and anode electrode material are deposited on current collectors, layered with separators, and wound to form the jelly roll configuration of the electrode assembly 220. The cathode electrode material and anode electrode material refer to active materials capable of the reversible insertion and extraction of a chemical species (i.e., lithium ions) that functions as the charge carrier in a Li-ion battery. The active materials may be any conventional electrode material. For example, the cathode or anode active material may be deposited on a current collector with a polymer binder and a conductive additive. The electrode assembly 220 is positioned in the housing 210 such that there is space surrounding the electrode assembly 220, e.g., there is space between the electrode assembly 220 and the housing 210 on the top, bottom, and side spaces. The side spaces correspond to the flat wound face of the electrode assembly 220, i.e. not the outermost wrapped layer. In an embodiment, the side spaces correspond to the layered side of the stack of the electrode assembly 220. The electrode assembly 220 is operated during routine usage and vehicle operation by implementing current flow between busbars for the cathode 270 and anode 280 via circuitry 260, 265. The electrical circuit is controlled by and connected to a battery management system (BMS) 240.

The battery 200 includes a lithium regenerating electrode (LRE) 230 positioned in the the housing 210 and spaced away, and electrically isolated, from the electrode assembly 220. As shown in FIGS. 2A-2B, the LRE 230 may be positioned vertically spaced away from and corresponding to a flat wound face of the electrode assembly 220 (in FIG. 2A), and spaced away from and corresponding to the layered side of the stack electrode assembly 220 (in FIG. 2B). In FIG. 2C, a cylindrical cell 200 is shown, with the wound electrode assembly in a vertical orientation. In FIG. 2C, the LRE 230 is spaced away from and corresponds to the flat wound face of the electrode assembly 220, and is positioned at the bottom of the battery 200. In an alternate embodiment, in the cylindrical cell, the LRE may be in the side space adjacent to the wound electrode assembly. The positioning with respect to the open face of the electrode assembly reduces side reactions with the LRE and reduces deposition build up. Isolating the LRE prevents expansion issues with the electrode, thus improving the physical integrity of the battery 200. The LRE 230 may be connected to a terminal post external to the battery for accessibility for connecting to the primary electrodes for regeneration.

As shown in FIG. 3, LRE 230 comprises an LRE current collector 310. Cathode or anode active material 320 is coated on the current collector 310. The current collector 310 and active material 320 are placed inside a separator membrane 330 for isolation, i.e., the active material and current collector are electrically isolated from the electrolyte 215 and electrode assembly 220. The separator 330 may be, but is not limited to, polyethylene, polypropylene, or polyolefin. The active material 320 is a high capacity material. The high capacity material is a high capacity active material, and may be a high capacity cathode material or a high capacity anode material. The capacity of the material is a value expressed in mAh/g. Energy density, expressed as Wh/kg or Wh/Liter, and capacity refer to the Li insertion capability of a material. Typically, conventional cathodes have capacity in the range 110-160 mAh/g. Conventional anodes, e.g. graphite, have capacity of 360 mAh/g. High capacity electrodes have capacities higher than the conventional electrodes. High capacity cathode materials may include, without limitation, Ni-rich NMC (nickel manganese cobalt oxide), lithiated sulfur, or xLi₂MnO₃·(1-x)LiZO₂, wherein Z is Mn, Co, or Ni and x is a value between 0 and 1 representing a percentage of the components in the composition complex. The cathode materials may be Li-rich systems. High capacity anode materials include, without limitation, lithiated metal hydrides (e.g., MgH₂, TiH₂, TiNiH), lithiated SnO₂, lithiated Co₃O₄, lithiated CuSn, and alloys of these systems, and materials such as lithiated Si, lithiated Sn, and lithiated Ge. High capacity material provides for a LRE with less active material (in weight and volume) to improve design and energy density considerations. The LRE is activated by BMS 240 to provide lithium ions to the primary cathode or primary anode of the electrode assembly 220 (based on the high capacity active material) when the battery capacity has decreased, as discussed further below.

In one embodiment, the LRE 230 uses high capacity cathode material for active material 320 and is activated by flowing a current in regeneration circuit 250 between the LRE 230 and anode 280 via the BMS 240. In another embodiment, the LRE 230 uses high capacity anode material for active material 320 and is activated by flowing a current in regeneration circuit 250 between the LRE 230 and cathode 270 via the BMS 240. The current applied may be low or medium to ensure Li is not plated on the primary electrodes of electrode assembly 220 following regeneration. For example, the low or medium current may be 0.1 C-0.5 C rate or equivalent based on the regeneration capacity.

The battery management system (BMS) 240 is connected to the battery 200 for estimating values descriptive of the battery pack and/or battery cells at present operating conditions. The present operating conditions may relate to those at a time after start during the usage of the battery pack or cells. The battery operating conditions include, without limitation, battery state of charge (SOC), aging, capacity changes, and instantaneous available power. The BMS 240 may be capable of estimating values during changing cell characteristics as the battery ages over its lifetime. The precise estimation of some parameters improves performance and robustness, and lengthens the useful time of the battery 200. The battery management system 240 may have one or more controllers, such as a Battery Energy Control Module (BECM), that monitor and control the performance of the traction battery 200. The battery 200 may include sensors to measure various level characteristics. The battery 200 may include one or more current measurement sensors, voltage measurement sensors, and temperature measurement sensors. The BECM may include circuitry to interface with the current sensors, the voltage sensors, and the temperature sensors. The BECM may have non-volatile memory such that data may be retained and available when the BECM is in an off condition (i.e. during ‘key OFF’). Retained data may also be available upon the next key cycle (i.e., during ‘key ON’).

Quantities such as battery power capability, battery capacity, and battery state of charge may be useful for controlling the operation of the battery 200 as well as any electrical loads receiving power from the battery 200. Battery power capability is a measure of the maximum amount of power the battery 200 can provide or the maximum amount of power that the battery 200 can receive. Knowing the battery power capability allows the electrical loads to be managed such that the power requested is within limits that the battery 200 can handle.

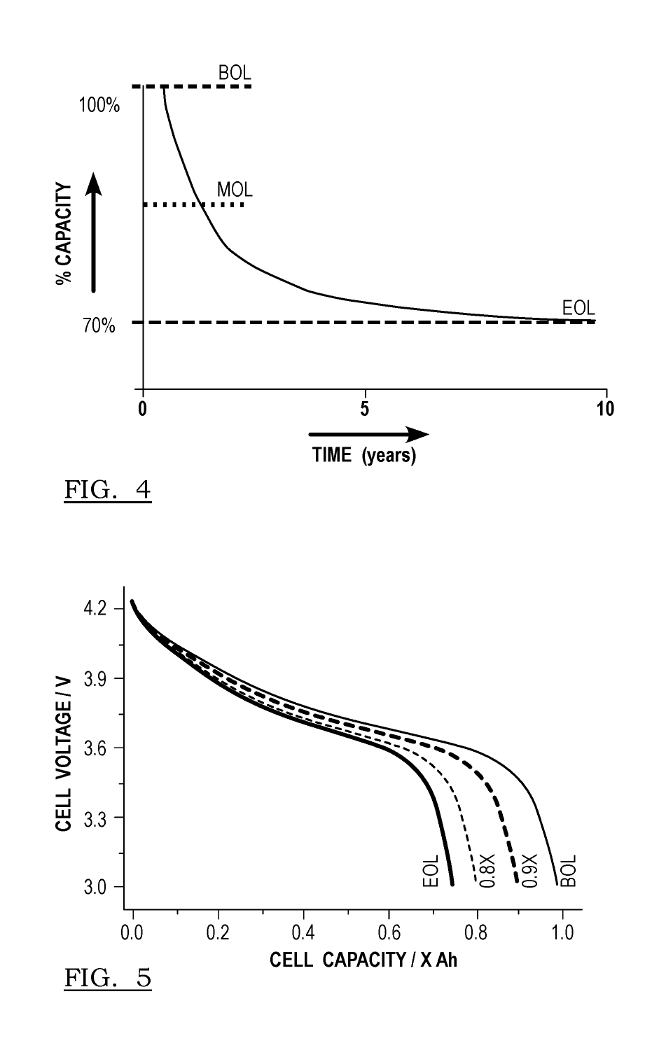

Battery capacity is a measure of a total amount of charge that may be stored in the battery 200. The battery capacity may be expressed in units of Amp-hours (Ah). Values related to the battery capacity may be referred to as Amp-hour values. The battery capacity of the battery 200 may decrease over the life of the battery 200. FIG. 4 depicts a graph of battery capacity over time. The battery capacity is shown as a percentage of the beginning of life (BOL), and shows middle of life (MOL) and end of life (EOL) percentage levels. The capacity of the battery 200 may decrease with time and vehicle usage. This may be referred to as aging of the battery 200. The battery decay or aging is characterized as a decrease in battery capacity and charge/discharge power capability. The battery decay can affect performance and fuel economy of hybrid vehicles if the control strategies are not updated to account for battery aging. In order to properly control the vehicle 100, it is useful to know the capacity as the battery 200 ages. FIG. 5 depicts aging via a graph of cell voltage over cell capacity at various stages of battery life. During usage and due to aging, the capacity decreases by MOL and EOL. For example, the battery capacity will be ˜90% of the BOL at MOL, and ˜75% of the BOL at EOL.

The BMS 240 electrically connects regeneration circuit 250 to the electrode assembly 220 (via BMS and to the corresponding cathode or anode based on the high capacity active material for the LRE 230) to activate lithium regeneration for replenishing lithium ions in the electrode assembly 220. BMS 240 activates lithium regeneration at a predefined percentage of battery capacity to counter capacity loss and aging. The predefined percentage may be at or prior to MOL, or a level before EOL. Regeneration circuit 250 may be activated during the course of usage when a percentage of capacity of the battery 200 is lost and the vehicle 100 is keyed-off.

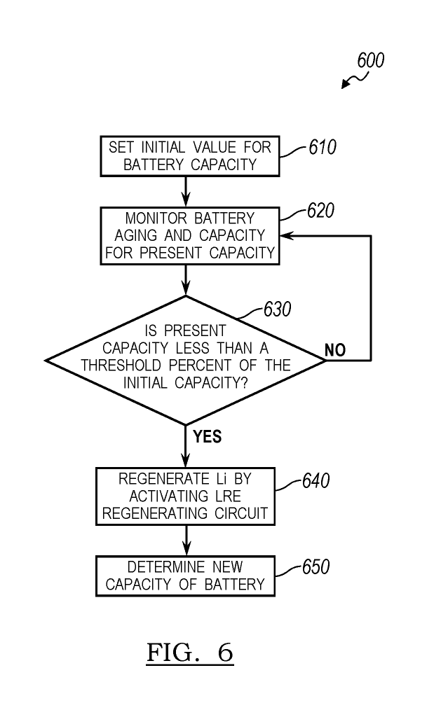

FIG. 6 depicts a method 600 for containing capacity loss in a battery. At block 610, the initial value for battery capacity is set. For a new battery, the battery capacity is the BOL, or full starting capacity. For a recharged or replenished battery, the initial capacity may be less than the full starting capacity due to battery degradation. At block 620, battery aging and capacity is monitored by the BMS to determine the present capacity of the battery. At block 630, the BMS compares the present capacity to the initial capacity. If the present capacity is not less than a predefined percent of the initial capacity, the BMS continues to monitor the battery aging and capacity at block 620. If the present capacity is less than the predefined percent of the initial capacity, at block 640, Li ions are replenished by activating the LRE regenerating circuit. At block 650, a new battery capacity is determined by the BMS for setting the initial value at block 610. The regeneration step may occur during vehicle key-off.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A lithium-ion battery comprising:
a housing;
an electrode assembly within the housing; and
a high capacity regenerating electrode within the housing, electrically isolated from the electrode assembly, spaced away from and only corresponding to a single face of the electrode assembly, and configured to be selectively electrically connected to the electrode assembly to provide lithium ions to increase capacity of the electrode assembly.

2. The battery of claim 1, wherein the electrode assembly is a wound assembly, and wherein the single face is a flat face of the wound assembly.

3. The battery of claim 1, wherein the high capacity regenerating electrode includes a separator encasing a current collector and a high capacity active material.

4. The battery of claim 3, wherein the high capacity active material is a high capacity cathode material.

5. The battery of claim 4, wherein the high capacity active material is Ni-rich NMC, lithiated sulfur, or xLi₂MnO₃·(1-x)LiZO₂, wherein Z is Mn, Co, or Ni and x is a value between 0 and 1 representing a percentage for each component.

6. The battery of claim 3, wherein the high capacity active material is a high capacity anode material.

7. The battery of claim 6, wherein the high capacity active material is
lithiated metal hydride,
lithiated SnO₂, lithiated Co₃O₄, lithiated CuSn, or alloys thereof,
lithiated Si,
lithiated Sn, or
lithiated Ge.

8. A system comprising:
a battery having
a housing,
an electrode assembly within the housing, and
a high capacity regenerating electrode within the housing, electrically isolated from, spaced away from, and only corresponding to a single face of the electrode assembly, and configured to be selectively electrically connected to the assembly via a circuit to increase capacity of the assembly; and
a controller configured to activate the circuit based on signals from a battery management system.

9. The system of claim 8, wherein the battery management system is configured to monitor battery capacity and degradation and output signals regarding the same.

10. The system of claim 8, wherein the electrode assembly is a wound assembly, and wherein the single face is a flat face of the wound assembly.

11. The system of claim 8, wherein the high capacity regenerating electrode includes a separator encasing a current collector and a high capacity active material.

12. The system of claim 11, wherein the high capacity active material is a high capacity cathode material.

13. The system of claim 12, wherein the high capacity active material is Ni-rich NMC, lithiated sulfur, or xLi₂MnO₃·(1-x)LiZO₂, wherein Z is Mn, Co, or Ni and x is a value between 0 and 1 representing a percentage for each component.

14. The system of claim 11, wherein the high capacity active material is a high capacity anode material.

15. The system of claim 14, wherein the high capacity active material is lithiated metal hydride,
lithiated SnO₂, lithiated Co₃O₄, lithiated CuSn, or alloys thereof,
lithiated Si,
lithiated Sn, or
lithiated Ge.

16. The system of claim 8, wherein the controller is configured to set an initial capacity of the battery and a new initial capacity after capacity of the electrode assembly is increased.

17. A lithium-ion battery comprising:
a housing;
a wound electrode assembly within the housing and having at least one face; and
a high capacity regenerating electrode within the housing, electrically isolated from the electrode assembly, spaced away from and only corresponding to a single face of the electrode assembly, and configured to be selectively electrically connected to the electrode assembly via a regeneration circuit to provide lithium ions to increase capacity of the electrode assembly.

18. The battery of claim 17, wherein the at least one face is a flat face of the wound assembly.

19. The battery of claim 17, wherein the high capacity regenerating electrode includes a separator encasing a current collector and a high capacity active material.

20. The battery of claim 17, wherein the regeneration circuit is activated by a controller responsive to signals from a battery management system configured to monitor battery capacity and degradation.
